(19) United States
(12) Patent Application Publication
(10) Pub. No.: US 2025/0003597 A1
(43) Pub. Date: Jan. 2, 2025

(54) Hot Air Cooking Appliance

(71) Applicant: SEB S.A., Ecully (FR)

(72) Inventors: Marie Dussart, Ecully Cedex (FR); Kévin Bony, Ecully Cedex (FR)

(73) Assignee: SEB S.A., Ecully (FR)

(21) Appl. No.: 18/758,610

(22) Filed: Jun. 28, 2024

(30) Foreign Application Priority Data
Jun. 28, 2023 (FR) 23/06759

(51) Int. Cl. F24C 7/08; F24C 15/00; F24C 15/32

(52) U.S. Cl. CPC F24C 7/08; F24C 15/007; F24C 15/325; F24C 15/327

(57) ABSTRACT

A cooking appliance includes a cooking chamber; a fan configured to generate an air flow in the cooking chamber; a drive unit configured to rotatably drive the fan; an upper heating device configured to heat the air flow generated by the fan; and a separation element configured to be located in the cooking chamber. The cooking appliance has a first use configuration in which the cooking appliance includes a first cooking compartment and a second cooking compartment which are delimited by the cooking chamber and the separation element, and a second use configuration in which the cooking appliance includes a single main cooking compartment delimited at least partly by the cooking chamber.

### TECHNICAL FIELD

The present invention generally concerns a cooking appliance for cooking food products, and in particular a multi-cooking appliance using at least one hot air cooking function.

### STATE OF THE ART

The document US2022/0202239 discloses an electric cooking appliance for cooking food in particular according to a hot air cooking mode. Such an electric cooking appliance includes:
a first cooking compartment and a second cooking compartment independent of each other, that is to say fluidly separated from each other, and respectively defining first and second cooking zones distinct from each other, and
first and second fans configured to respectively generate a first air flow in the first cooking compartment and a second air flow in the second cooking compartment, and
first and second heating devices configured to respectively heat the first and second generated air flows.

Such an electric cooking appliance allows food to be cooked in the first and second cooking compartments with different cooking types, at different temperatures and with different cooking times.

However, the dimensions of the first and second cooking compartments do not allow the cooking of a large quantity of food at one time, nor the cooking of a bulky dish, unless the electric cooking appliance is oversized, which would significantly increase the manufacturing costs and the size of the electric cooking appliance.

### SUMMARY OF THE INVENTION

The technical problem underlying the invention consists in particular of providing a cooking appliance for cooking food in particular according to a hot air cooking mode which is compact and multifunctional, while allowing the cooking of a significant quantity of food at once and while allowing the simultaneous cooking of different foods in independent cooking compartments.

To this end, the present invention concerns a cooking appliance configured for cooking food, the cooking appliance including:
a cooking chamber,
a fan configured to generate an air flow in the cooking chamber,
a drive unit configured to rotatably drive the fan,
a heating device associated with the fan and configured to heat the air flow generated by the fan,
a lower heating device configured to heat the cooking chamber, and
a separation element configured to be located in the cooking chamber.

The cooking appliance has a first use configuration in which the cooking appliance includes a first cooking compartment and a second cooking compartment which are delimited by the cooking chamber and by the separation element and in which a food disposed in the first cooking compartment is capable of being heated by at least one of the upper heating device and the lower heating device and a food disposed in the second cooking compartment is capable of being heated by at least one of the upper heating device and the lower heating device, and a second use configuration in which the cooking appliance includes a single main cooking compartment delimited at least in part by the cooking chamber and in which a food disposed in the main cooking compartment is capable of being heated by both the upper heating device and the lower heating device.

Such a configuration of the cooking appliance allows, when the cooking appliance is in the first use configuration, the cooking of foods disposed in the first and second cooking compartments with different types of cooking, at different temperatures and with different cooking times, and allows, when the cooking appliance is in the second use configuration, the cooking, in the main cooking compartment, of food contained in a bulky dish or a large quantity of food.

Thus, the cooking appliance according to the present invention allows the cooking of a wide variety of foods while being compact.

The cooking appliance may further have one or more of the following features, which may be taken alone or in combination.

According to one embodiment of the invention, when the cooking appliance is in the second use configuration, the main cooking compartment is directly exposed to both the upper heating device and the lower heating device.

According to one embodiment of the invention, the first and second cooking compartments are independent of each other, that is to say fluidly separated from each other, when the cooking appliance is in the first use configuration. Advantageously, the separation element is configured to fluidly separate the first cooking compartment and the second cooking compartment (that is to say to prevent a fluid communication between the first and second cooking compartments through the separation element) when the cooking appliance is in the first use configuration.

According to one embodiment of the invention, the cooking appliance is of the oven type.

According to one embodiment of the invention, the main cooking compartment has a cooking volume substantially corresponding to the sum of the cooking volumes of the first and second cooking compartments. A ratio of the cooking volume of the main cooking compartment to the sum of the cooking volumes of the first and second cooking compartments can for example be comprised between 1.1 and 1.2.

According to one embodiment of the invention, the cooking appliance includes a control unit configured to control the operation of the cooking appliance according to a hot air cooking mode. Thus, the cooking appliance is configured to cook food contained in the cooking chamber, and for example in the main cooking compartment or at least one of the first and second cooking compartments, according to a hot air cooking mode.

According to one embodiment of the invention, the separation element is configured to separate, that is to say to divide, the cooking chamber into the first cooking compartment and the second cooking compartment when the cooking appliance is in the first use configuration.

According to one embodiment of the invention, the separation element forms at least one wall, for example a lateral wall, an upper wall or a lower wall, of each of the first and second compartments.

According to one embodiment of the invention, the separation element has a general plate shape, and can for example be a separation plate.

According to one embodiment of the invention, the separation element is metallic.

According to one embodiment of the invention, the cooking chamber includes an access opening, and the cooking appliance includes a movable door between a closing position in which the door closes the access opening and prevents an access to the cooking chamber, and an opening position in which the door releases the access opening and authorizes access to the cooking chamber. When the door is in the opening position and the cooking appliance is in the first use configuration, the door authorizes access to both the first and second cooking compartments, and when the door is in the opening position and the cooking appliance is in the second use configuration, the door authorizes access to the main cooking compartment.

According to one embodiment of the invention, the cooking appliance includes a first door associated with the first cooking compartment and movable between a closing position in which the first door prevents access to the first cooking compartment and an opening position in which the first door authorizes access to the first cooking compartment, and a second door associated with the second cooking compartment and movable between a closing position in which the second door prevents access to the second cooking compartment and an opening position in which the second door authorizes access to the second cooking compartment.

According to one embodiment of the invention, the door is pivotally mounted about a pivot axis which is substantially horizontal when the cooking appliance rests on a horizontal surface. Advantageously, the pivot axis is located near a lower front edge of a frame of the cooking appliance.

According to one embodiment of the invention, the first door and the second door are pivotally mounted about the pivot axis which is substantially horizontal when the cooking appliance rests on a horizontal surface.

According to one embodiment of the invention, the cooking appliance includes a first cooking tank and a second cooking tank configured to receive food to be cooked and configured to be received at least in part respectively in the first cooking compartment and the second cooking compartment. Advantageously, the first cooking tank and the second cooking tank are configured to be introduced respectively into the first cooking compartment and the second cooking compartment via the access opening.

According to one embodiment of the invention, the first cooking tank and the second cooking tank are independent of each other, and are capable of being removed from the cooking chamber independently.

According to one embodiment of the invention, the first cooking tank and the second cooking tank are configured to authorize a free displacement of the door or the first door and the second door between the closing position and the opening position when the first cooking tank and the second cooking tank are located respectively inside the first cooking compartment and the second cooking compartment.

According to one embodiment of the invention, each of the first cooking tank and the second cooking tank includes a tank body and a gripping handle which is removably fixed to the respective tank body.

Such a configuration of the invention allows the insertion of the first cooking tank and the second cooking tank inside the cooking chamber, then removing the gripping handles so as not to unnecessarily clutter the cooking chamber, nor hinder the closing of the door or the first door and the second door.

According to one embodiment of the invention, each gripping handle extends at least partly facing a front face of the respective tank body.

According to one embodiment of the invention, the first cooking tank and the second cooking tank respectively form a first cooking drawer and a second cooking drawer.

According to one embodiment of the invention, the upper heating device is disposed in an upper part of the cooking appliance.

According to one embodiment of the invention, the upper heating device is located opposite the cooking chamber. Such an arrangement of the upper heating device makes it possible to gratinate, at the end of cooking, the food contained in the main cooking compartment or in at least one of the first and second cooking compartments.

According to one embodiment of the invention, the upper heating device includes a resistive heating element.

According to one embodiment of the invention, the lower heating device is disposed in a lower part of the cooking appliance. The lower heating device can for example be disposed in a lower part of the cooking chamber.

According to one embodiment of the invention, the lower heating device includes a resistive heating element.

According to one embodiment of the invention, when the cooking appliance is in the first use configuration, the separation element is configured to authorize a flowing of air flow, generated by the fan, in the first cooking compartment and to prevent a flowing of said air flow into the second cooking compartment.

According to one embodiment of the invention, the cooking appliance has a first variant of the first use configuration in which the separation element is configured to extend substantially horizontally and the first and second cooking compartments are configured to be disposed one above the other, when the cooking appliance rests on a horizontal surface.

According to one embodiment of the invention, when the cooking appliance is in the first variant of the first use configuration, a food disposed in the first cooking compartment is able to be heated only by the upper heating device, and a food disposed in the second cooking compartment is able to be heated only by the lower heating device. In other words, when the cooking appliance is in the first variant of the first use configuration, the first cooking compartment is directly exposed only to the upper heating device, and the second cooking compartment is directly exposed only to the lower heating device.

According to one embodiment of the invention, the cooking appliance is configured to generate a hot air flow only in the first cooking compartment when the cooking appliance is in the first variant of the first use configuration.

According to one embodiment of the invention, the cooking appliance has a second variant of the first use configuration in which the separation element is configured to extend substantially vertically and the first and second cooking compartments are configured to be disposed next to each other, when the cooking appliance rests on a horizontal surface.

According to one embodiment of the invention, the cooking appliance is configured to respectively generate a first hot air flow in the first cooking compartment but also a second hot air flow in the second cooking compartment when the cooking appliance is in the second variant of the first use configuration.

According to one embodiment of the invention, the cooking appliance includes two fans configured to respectively generate a first air flow in the first cooking compartment and a second air flow in the second cooking compartment, and two upper heating devices associated respectively with the two fans and configured to respectively heat the first and second air flows generated by the two fans. Advantageously, the two upper heating devices are configured to be located respectively opposite the first and second cooking compartments.

According to one embodiment of the invention, the cooking appliance includes two lower heating devices configured to heat the cooking chamber and to be associated respectively with the first and second cooking compartments.

According to one embodiment of the invention, when the cooking appliance is in the second variant of the first use configuration, a food disposed in the first cooking compartment is capable of being heated at the same time by the respective upper heating device and the respective lower heating device, and a food disposed in the second cooking compartment is capable of being heated by both the respective upper heating device and the respective lower heating device. In other words, when the cooking appliance is in the second variant of the first use configuration, the first cooking compartment is directly exposed to both the respective upper heating device and the respective lower heating device, and the second cooking compartment is directly exposed to both the respective upper heating device and the respective lower heating device.

According to one embodiment of the invention, the cooking appliance includes two distinct drive units associated respectively with the two fans.

According to one embodiment of the invention, the cooking appliance includes a user interface, for example provided on the frame of the cooking appliance, configured to allow a user to select at least one operating parameter of the cooking appliance, and for example at least one operating mode of the cooking appliance.

According to one embodiment of the invention, the separation element is removable, the separation element being located in the cooking chamber when the cooking appliance is in the first use configuration and being able to be removed from the cooking chamber, that is to say located outside the cooking chamber, when the cooking appliance is in the second use configuration. Such a configuration of the separation element makes it possible to limit the manufacturing costs of the cooking appliance, while allowing easy cleaning of the separation element.

According to one embodiment of the invention, the separation element is configured to be inserted into and removed from the cooking chamber via the access opening.

According to one embodiment of the invention, the separation element is movably mounted in the cooking chamber between a first position in which the separation element and the cooking chamber delimit at least the first cooking compartment and the second cooking compartment, and a second position in which the separation element and the cooking chamber delimit the single main cooking compartment. Such a configuration of the separation element allows a user to be able to easily displace the cooking appliance between the first and second use configurations.

According to one embodiment of the invention, the separation element is configured to be displaced manually between the first and second positions.

According to one embodiment of the invention, the cooking appliance includes a displacement mechanism configured to displace the separation element between the first and second positions.

According to one embodiment of the invention, the user interface is configured to allow a user to select a use configuration of the cooking appliance among the first and second use configurations. Advantageously, the control unit is configured to control the operation of the displacement mechanism according to the use configuration selected by the user, so as to automatically displace the separation element between the first and second positions.

According to one embodiment of the invention, the separation element is movably mounted in translation, and for example slidably mounted, relative to a frame of the cooking appliance according to a displacement direction.

According to one embodiment of the invention, the displacement direction extends substantially perpendicular to an extension plane of the separation element.

According to one embodiment of the invention, the displacement direction is substantially horizontal when the cooking appliance rests on a horizontal surface.

According to one embodiment of the invention, the displacement direction is substantially vertical when the cooking appliance rests on a horizontal surface.

According to one embodiment of the invention, the pivot axis of the door extends substantially perpendicular to the displacement direction.

According to another embodiment of the invention, the pivot axis of the door extends substantially parallel to the displacement direction.

According to one embodiment of the invention, the separation element is configured to form a bottom wall of the main cooking compartment when the separation element occupies the second position.

According to one embodiment of the invention, the separation element is configured to form a lateral wall of the main cooking compartment when the separation element occupies the second position.

According to one embodiment of the invention, the separation element includes a gripping part configured to be grasped by a user. The presence of such a gripping part allows a user to be able to easily displace the separation element between the first and second positions or to easily remove the separation element from the cooking chamber.

According to one embodiment of the invention, the lower heating device is configured to be covered by the separation element when the separation element occupies the second position.

According to one embodiment of the invention, the cooking appliance includes a steam generating device configured to generate a steam flow in the cooking chamber.

According to one embodiment of the invention, a food disposed in the first cooking compartment is capable of being in contact with the steam flow generated by the steam generating device and/or a food disposed in the second cooking compartment is capable of being in contact with the steam flow generated by the steam generating device when the cooking appliance is in the first use configuration, and a food disposed in the main cooking compartment is capable of being in contact with the steam flow generated by the steam generating device when the cooking appliance is in the second use configuration.

According to one embodiment of the invention, the control unit is configured to control the operation of the cooking appliance according to a steam cooking mode, and in particular to control the operation of the cooking appliance simultaneously according to a hot air and steam cooking mode.

According to one embodiment of the invention, the control unit is configured to control the operation of the steam generating device independently of the operation of the upper heating device and/or the lower heating device when the cooking appliance is in the first use configuration or in the second use configuration.

According to one embodiment of the invention, the control unit is configured to control the operation of the steam generating device and simultaneously control the operation of the upper heating device and/or the lower heating device when the cooking appliance is in the first use configuration or in the second use configuration. In other words, the cooking appliance is configured to carry out a cooking which combines the use of the steam generator, the upper heating device and the fan in the first cooking compartment, and the simultaneous carrying out of a cooking which only uses the lower heating device in the second cooking compartment for example. Such a configuration of the invention makes it possible to carry out different cooking operations simultaneously in the same cooking appliance and thus save time when carrying out different culinary preparations.

### BRIEF DESCRIPTION OF THE FIGURES

The present invention will be better understood using the description which follows with reference to the appended figures, in which identical reference signs correspond to structurally and/or functionally identical or similar elements.

FIG. 1 is a partial front perspective view of a cooking appliance according to a first embodiment of the invention, showing the cooking appliance in a first variant of a first use configuration;

FIG. 2 is a partial front perspective view of the cooking appliance of FIG. 1, showing the removal of a separation element belonging to the cooking appliance;

FIG. 3 is a partial front perspective view of the cooking appliance of FIG. 1, showing the cooking appliance in a second use configuration;

FIG. 4 is another partial front perspective view of the cooking appliance of FIG. 1, showing the cooking appliance in a second use configuration;

FIG. 5 is a partial front perspective view of a cooking appliance according to a second embodiment of the invention, showing the cooking appliance in a second variant of a first use configuration;

FIG. 6 is a partial front perspective view of the cooking appliance of FIG. 5, showing the removal of a separation element belonging to the cooking appliance;

FIG. 7 is a partial front perspective view of the cooking appliance of FIG. 5, showing the cooking appliance in a second use configuration;

FIG. 8 is another partial front perspective view of the cooking appliance of FIG. 7, showing the cooking appliance in a second use configuration;

FIG. 9 is a partial front perspective view of a cooking appliance according to a third embodiment of the invention, showing the cooking appliance in a first use configuration;

FIG. 10 is a partial front perspective view of the cooking appliance of FIG. 9, showing the cooking appliance in a second use configuration;

FIG. 11 is a partial front perspective view of a cooking appliance according to yet a fourth embodiment of the invention, showing the cooking appliance in a first use configuration;

FIG. 12 is a partial front perspective view of the cooking appliance of FIG. 11, showing the cooking appliance in a second use configuration.

### DETAILED DESCRIPTION

In this document, the terms «lower» and «upper» used to describe the cooking appliance refer to the cooking appliance in use, that is to say resting on a horizontal surface.

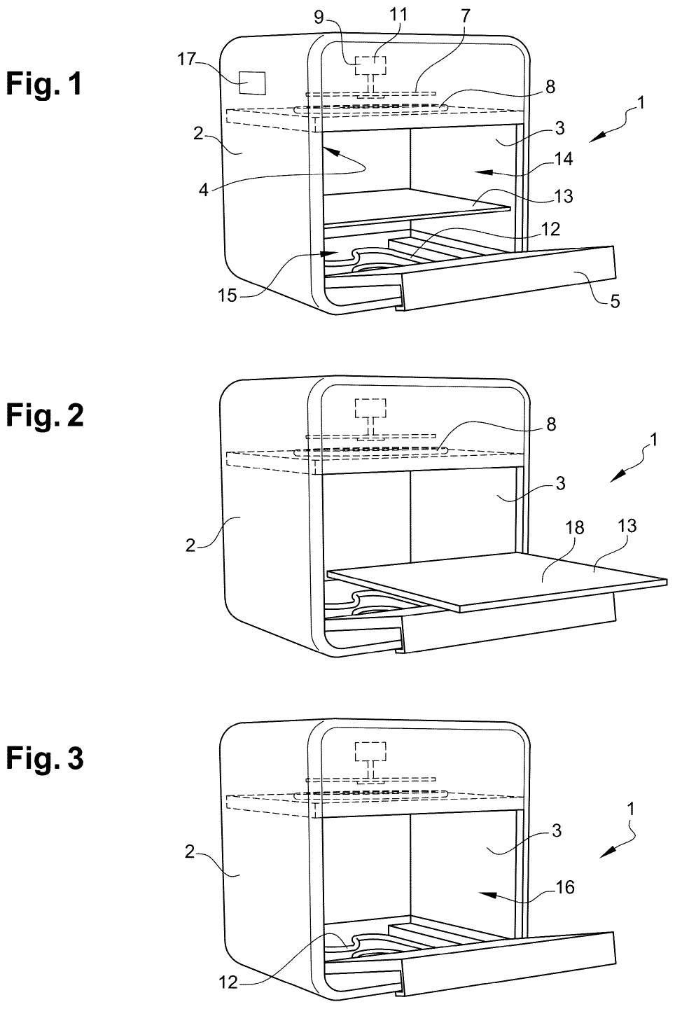

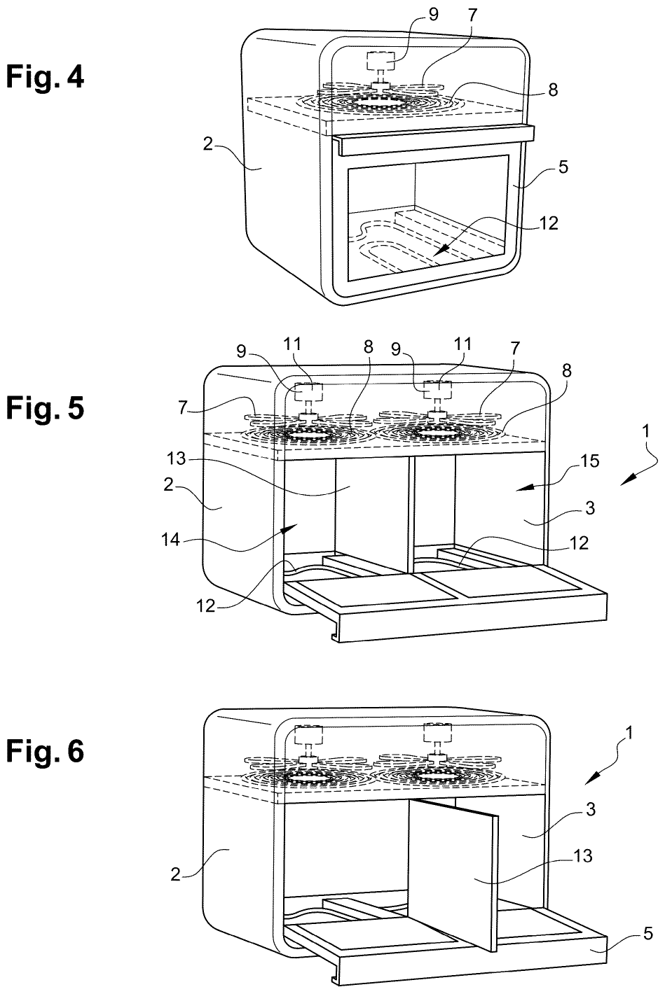

FIGS. 1 to 4 represent a cooking appliance 1 according to a first embodiment of the invention. The cooking appliance 1 is configured for cooking food, such as meat, fish, vegetables or other food products, in particular using a hot air cooking mode.

The cooking appliance 1 includes a frame 2 delimiting a cooking chamber 3 provided with an access opening 4, and a door 5 movable between a closing position in which the door 5 closes the access opening 4 and prevents access to the cooking chamber 3, and an opening position in which the door 5 releases the access opening 4 and authorizes access to the cooking chamber 3. The door 5 can for example be pivotally mounted about a pivot axis which is substantially horizontal when the cooking appliance 1 rests on a horizontal surface and which is advantageously located near a lower front edge of the frame 2.

The cooking appliance 1 further includes a fan 7 configured to generate an air flow in the cooking chamber 3, and an upper heating device 8 configured to heat the air flow generated by the fan 7. Advantageously, the upper heating device 8 includes a resistive heating element and is located opposite the cooking chamber 3.

The cooking appliance 1 further includes a drive unit 9 which is provided with a drive motor 11 and which is configured to rotatably drive the fan 7 about an axis of rotation. Advantageously, the axis of rotation is substantially vertical when the cooking appliance 1 rests on a horizontal surface. The fan 7 can for example be directly coupled in rotation to an output shaft of the drive motor 11, or be coupled to the latter via a movement transmission mechanism configured to transmit a rotational movement of the drive motor 11 to the fan 7.

According to the first embodiment of the invention, the drive unit 9 and the fan 7 are disposed above the upper heating device 8, and are not accessible to a user. The drive unit 9 and the fan 7 can for example be disposed in an internal housing disposed above the cooking chamber 3 and delimited by the frame 2.

The cooking appliance 1 also includes a lower heating device 12 which is disposed in a lower part of the cooking chamber 3 and which is configured to heat the cooking chamber 3 by conduction. Advantageously, the lower heating device 12 includes a resistive heating element.

The cooking appliance 1 further includes a separation element 13, such as a separation plate, configured to be located in the cooking chamber 3. The separation element 13 can for example be metallic.

The cooking appliance 1 has more particularly a first use configuration in which the cooking appliance 1 includes a first cooking compartment 14 and a second cooking compartment 15 which are delimited by the separation element 13 and the cooking chamber 3 and which are independent of each other, and a second use configuration in which the cooking appliance 1 includes a single main cooking compartment 16 delimited at least partly by the cooking chamber 3. Advantageously, the separation element 13 is configured to separate the cooking chamber 3 into the first cooking compartment 14 and the second cooking compartment 15 when the cooking appliance 1 is in the first use configuration.

The first and second cooking compartments 14, 15 can for example have identical or different cooking volumes and identical or different shapes, and the main cooking compartment 16 advantageously has a cooking volume corresponding substantially to the sum of the cooking volumes of the first and second cooking compartments 14, 15.

When the door 5 occupies the opening position and the cooking appliance 1 is in the first use configuration, the door 5 authorizes access to the first and second cooking compartments 14, 15 via the access opening 4, and when the door 5 occupies the opening position and the cooking appliance 1 is in the second use configuration, the door 5 authorizes access to the main cooking compartment 16 via the access opening 4.

According to the first embodiment of the invention, the separation element 13 is removable, and is configured to be inserted into and removed from the cooking chamber 3 via the access opening 4. The first use configuration of the cooking appliance 1 corresponds more particularly to a use configuration in which the separation element 13 is located in the cooking chamber 3, while the second use configuration of the cooking appliance 1 corresponds more particularly to a use configuration in which the separation element 13 is removed, that is to say is located outside the cooking chamber 3.

Advantageously, the cooking appliance 1, and more particularly the lateral walls of the cooking chamber 3, can be provided with fixing devices (not shown in the figures), such as fixing grooves or slides or the like, configured to allow the insertion and the retention of the lateral portions of the separation element 13 in the cooking chamber 3.

According to the first embodiment of the invention, and therefore according to a first variant of the first use configuration, the separation element 13 is configured to extend substantially horizontally and the first and second cooking compartments 14, 15 are configured to be disposed one above the other, when the cooking appliance 1 rests on a horizontal surface and is in the first use configuration. Thus, the cooking appliance 1 is configured to generate a hot air flow only in the first cooking compartment 14 when the cooking appliance 1 is in the first use configuration, and to generate a hot air flow in the main cooking compartment 16 when the cooking appliance 1 is in the second use configuration.

According to the first embodiment of the invention, when the cooking appliance 1 is in the first variant of the first use configuration, the first cooking compartment 14 is directly exposed only to the upper heating device 8, and the second cooking compartment 15 is directly exposed only to the lower heating device 12. Thus, a food disposed in the first cooking compartment 14 is able to be heated only by, or at least essentially by, the upper heating device 8, and a food disposed in the second cooking compartment 15 is capable of being heated only by, or at least essentially by, the lower heating device 12.

The cooking appliance 1 also includes a control unit 17 which includes for example a controller, such as a microcontroller, or a processor, such as a microprocessor, and which is configured to control the operation of the cooking appliance 1, and in particular of the upper heating device 8, the lower heating device 12, the drive motor 11 and the fan 7.

The control unit 17 is more particularly configured to control the operation of the cooking appliance 1 according to a hot air cooking mode. The user can then control a hot air cooking mode using a user interface provided on the frame 2, and the control unit 17 then controls an activation of the drive motor 11 so as to rotatably drive the fan 7 and generate an air flow within the cooking chamber 3 and also an electrical supply to the upper heating device 8 so as to heat this air flow. Such a cooking mode can for example be used to cook food contained in the main cooking compartment 16 when the cooking appliance 1 is in the second use configuration, or to cook food contained in the first cooking compartment 14 when the cooking appliance 1 is in the first use configuration. Food contained in the second cooking compartment 15 can be cooked by electrically powering the lower heating device 12.

The cooking appliance 1 according to the present invention also makes it possible to gratinate the food contained in the main cooking compartment 16 or in the first cooking compartment 14. For example, by selecting a gratinated cooking mode, the control unit 17 can control, at the end of the hot air cooking cycle, a stopping of the drive motor 11 while maintaining an electrical supply to the upper heating device 8, which ensures, due to the position of the latter facing the cooking chamber 3, a gratinated cooking of food.

Advantageously, the cooking appliance 1, and more particularly the lateral walls of the cooking chamber 3, can be provided with retaining devices (not shown in the figures) configured to allow the insertion and the retention of cooking accessories, such as cooking plates, cooking grids or drip pans, in the main cooking compartment 16 and in the first and second cooking compartments 14, 15.

In order to facilitate the removal and the insertion of the separation element 13 into and out of the cooking chamber 3, the separation element 13 can advantageously be provided with a gripping part 18 configured to be grasped by a user.

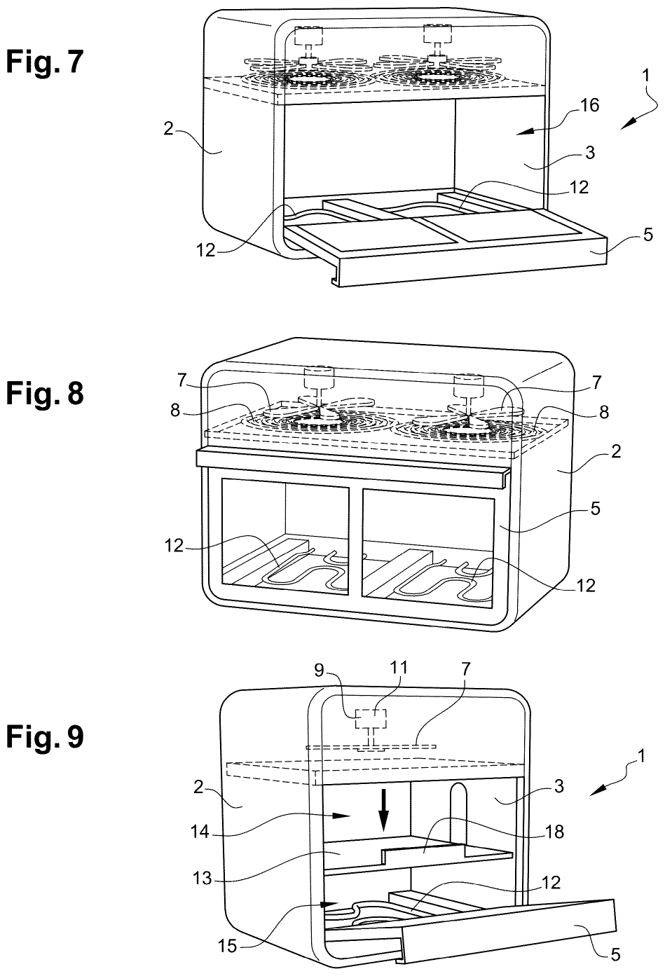

FIGS. 5 to 8 represent a cooking appliance 1 according to a second embodiment of the invention and according to a second variant of the first use configuration, which differs from the first embodiment essentially in that the separation element 13 is configured to extend substantially vertically and in that the first and second cooking compartments 14, 15 are configured to be disposed next to each other, when the cooking appliance 1 rests on a horizontal surface and is in the first use configuration.

According to the second embodiment of the invention, and therefore according to a second variant of the first use configuration, the cooking appliance 1 is configured to respectively generate a first hot air flow in the first cooking compartment 14 and a second hot air flow in the second cooking compartment 15, when the cooking appliance 1 is in the first use configuration. For this purpose, the cooking appliance 1 comprises two fans 7 configured to respectively generate the first and second air flows respectively in the first and second cooking compartments 14, 15, and two upper heating devices 8 associated respectively with the two fans 7 and configured to respectively heat the first and second air flows generated by the two fans 7. Advantageously, the two upper heating devices 8 are configured to be located respectively opposite the first and second cooking compartments 14, 15. The control unit 17 is advantageously configured to independently control the two fans 7 and to independently control the two upper heating devices 8.

According to the second embodiment of the invention, the cooking appliance 1 includes two distinct drive units 9 associated respectively with the two fans 7. However, according to a variant of the invention, the cooking appliance 1 could include a single drive unit 9, and therefore a single drive motor 11, configured to simultaneously drive the two fans 7 in rotation.

According to such an embodiment of the invention, the cooking appliance 1 advantageously includes two lower heating devices 12 configured to be associated respectively with the first and second cooking compartments 14, 15.

According to the second embodiment of the invention, when the cooking appliance 1 is in the first use configuration, the first cooking compartment 14 is directly exposed to both the upper heating device 8 and the lower heating device 12, and the second cooking compartment 15 is directly exposed to both the upper heating device 8 and the lower heating device 12. Thus, a food disposed in the first cooking compartment 14 is able to be heated at the same time by the upper heating device 8 and the lower heating device 12, and a food disposed in the second cooking compartment 15 is capable of being heated at the same time by the upper heating device 8 and the lower heating device 12.

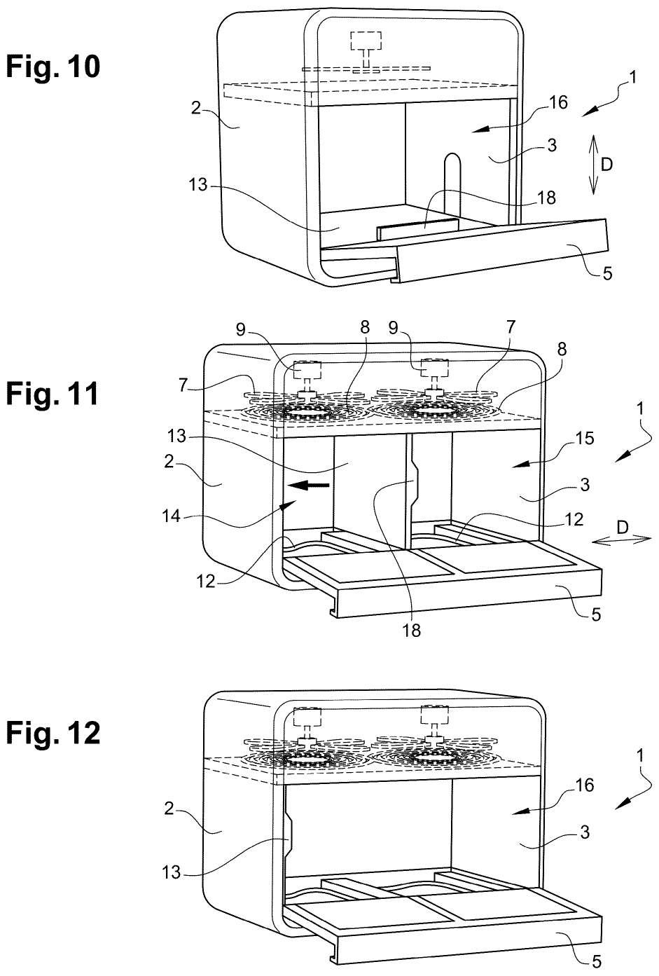

FIGS. 9 and 10 represent a cooking appliance 1 according to a third embodiment of the invention which differs from the first embodiment essentially in that the separation element 13 is movably mounted in the cooking chamber 3 between a first position (see FIG. 9) in which the separation element 13 and the cooking chamber 3 delimit the first and second cooking compartments 14, 15, and a second position (see FIG. 10) in which the separation element 13 and the cooking chamber 3 delimit the single main cooking compartment 16. Advantageously, the separation element 13 is slidably mounted relative to the frame 2 of the cooking appliance 1 in a displacement direction D which extends substantially perpendicular to an extension plane of the separation element 13.

According to the third embodiment of the invention illustrated in FIGS. 9 and 10, the displacement direction D is substantially vertical when the cooking appliance 1 rests on a horizontal surface, and the pivot axis of the door 5 extends substantially perpendicular to the displacement direction D.

According to the third embodiment of the invention, the separation element 13 is configured to form a bottom wall of the main cooking compartment 16 and to cover the lower heating device 12 when the separation element 13 occupies the second position.

The separation element 13 can for example be configured to be displaced manually between the first and second positions. In order to facilitate the gripping and the displacement of the separation element 13 between the first and second positions, the separation element 13 is advantageously provided with a gripping part 18 configured to be grasped by a user.

According to a variant of the invention, the cooking appliance 1 could include a displacement mechanism configured to automatically displace the separation element 13 between the first and second positions. For this purpose, the user interface is advantageously configured to allow a user to select the use configuration of the cooking appliance 1 among the first and second use configurations, and the control unit 17 is configured to control the operation of the displacement mechanism according to the use configuration selected by the user, so as to automatically displace the separation element 13 between the first and second positions.

FIGS. 11 and 12 represent a cooking appliance 1 according to a fourth embodiment of the invention which differs from the second embodiment essentially in that the displacement direction D is substantially horizontal when the cooking appliance 1 rests on a horizontal surface, and the pivot axis of the door 5 extends substantially parallel to the displacement direction D.

According to the fourth embodiment of the invention, the separation element 13 is configured to form a lateral wall of the main cooking compartment 16 when the separation element 13 occupies the second position.

According to an embodiment of the invention not shown in the figures, the cooking appliance 1 could be configured to include more than two cooking compartments when it is in the first use configuration.

According to an embodiment of the invention not shown in the figures, the cooking appliance 1 could include a first door associated with the first cooking compartment 14 and movable between a closing position in which the first door prevents access to the first cooking compartment 14 and an opening position in which the first door authorizes access to the first cooking compartment 14, and a second door associated with the second cooking compartment 15 and movable between a closing position in which the second door prevents access to the second cooking compartment 15 and an opening position in which the second door authorizes access to the second cooking compartment 15. Such a configuration of the cooking appliance 1 allows access to one of the first and second cooking compartments 14, 15 by opening the respective door, without impacting the cooking of the food disposed in the other of the first and second cooking compartments 14, 15.

According to a variant of the previous embodiment, the cooking appliance 1 may include a first cooking tank and a second cooking tank configured to receive food to be cooked and configured respectively to be received at least in part respectively in the first cooking compartment 14 and in the second cooking compartment 15.

Each of the first cooking tank and the second cooking tank includes a tank body and a gripping handle that is removably fixed to the respective tank body. Such a configuration of the invention allows the insertion of the first cooking tank and the second cooking tank inside the cooking chamber 3, then removing the gripping handles so as not to unnecessarily clutter the cooking chamber, nor hinder the closing of the door.

Advantageously, the gripping handle fitted to each of the first and second cooking tanks extends at least partly facing a front face of the respective tank body.

Furthermore, the first cooking tank and the second cooking tank are configured to authorize a free displacement of the door or the first door and the second door between the closing position and the opening position when the first cooking tank and the second cooking tank are located respectively inside the first cooking compartment and the second cooking compartment.

According to another embodiment of the invention not shown in the figures, the cooking appliance 1 includes a steam generating device configured to generate a steam flow in the cooking chamber 3. More precisely, a food disposed in the first cooking compartment 14 is able to be in contact with the steam flow generated by the steam generating device and a food disposed in the second cooking compartment 15 is able to be in contact with the steam flow generated by the steam generating device when the cooking appliance 1 is in the first use configuration, and a food disposed in the main cooking compartment 16 is capable of being in contact with the steam flow generated by the steam generating device when the cooking appliance 1 is in the second use configuration.

Furthermore, the control unit UC is configured to control the operation of the cooking appliance 1 in a steam cooking mode, and in particular to control the operation of the cooking appliance simultaneously in a hot air and steam cooking mode. More particularly, the control unit UC is configured to control the operation of the steam generating device independently of the operation of the upper heating device 8 and/or the lower heating device 12 when the cooking appliance 1 is in the first use configuration or in the second use configuration.

For example, the cooking appliance 1 is configured to carry out a cooking which combines the use of the steam generator, the upper heating device 8 and the fan 7 in the first cooking compartment 14, and the simultaneous carrying out of a cooking which only uses the lower heating device 12 in the second cooking compartment 15 for example. Such a configuration of the invention advantageously makes it possible to carry out different cooking operations simultaneously in a same cooking appliance and thus to save time when carrying out different culinary preparations.

Of course, the present invention is in no way limited to the embodiments described and illustrated which have been given only by way of example. Modifications remain possible, particularly from the point of view of the constitution of the various elements or by substitution of technical equivalents, without departing from the scope of protection of the invention.

1. A cooking appliance configured for cooking food, comprising:
a cooking chamber,
a fan configured to generate an air flow in the cooking chamber,
a drive unit configured to rotatably drive the fan,
an upper heating device associated with the fan and configured to heat the air flow generated by the fan (7),
a lower heating device configured to heat the cooking chamber, and
a separation element configured to be located in the cooking chamber,
wherein the cooking appliance has a first use configuration in which the cooking appliance includes a first cooking compartment and a second cooking compartment which are delimited by the cooking chamber and by the separation element, and in which a food disposed in the first cooking compartment is capable of being heated by at least one of the upper heating device and the lower heating device and a food disposed in the second cooking compartment is capable of being heated by at least one of the upper heating device and the lower heating device, and a second use configuration in which the cooking appliance includes a single main cooking compartment delimited at least in part by the cooking chamber and in which a food disposed in the main cooking compartment is capable of being heated at the same time by the upper heating device and the lower heating device.

2. The cooking appliance according to claim 1, wherein the main cooking compartment has a cooking volume corresponding to the sum of the cooking volumes of the first and second cooking compartments.

3. The cooking appliance according to claim 1, wherein the separation element has a general plate shape.

4. The cooking appliance according to claim 1, wherein the cooking chamber includes an access opening, and the cooking appliance includes a door movable between a closing position in which the door closes the access opening and prevents access to the cooking chamber, and an opening position in which the door releases the access opening and authorizes access to the cooking chamber.

5. The cooking appliance according to claim 4, wherein the door is pivotally mounted about a pivot axis which is substantially horizontal when the cooking appliance rests on a horizontal surface.

6. The cooking appliance according to claim 1, further comprising a first cooking tank and a second cooking tank configured to receive food to be cooked and respectively configured to be received at least partly in the first cooking compartment and the second cooking compartment.

7. The cooking appliance according to claim 6, wherein each of the first cooking tank and the second cooking tank includes a tank body and a gripping handle removably fixed to the respective tank body.

8. The cooking appliance according to claim 1, wherein, when the cooking appliance rests on a horizontal surface and is in the first use configuration, the separation element extends substantially horizontally and the first and second cooking compartments are disposed one above the other.

9. The cooking appliance according to claim 1, wherein, when the cooking appliance rests on a horizontal surface and is in the first use configuration, the separation element extends substantially vertically and the first and second cooking compartments are disposed next to each other.

10. The cooking appliance according to claim 1, wherein the separation element is movably mounted in the cooking chamber between a first position in which the separation element and the cooking chamber delimit at least the first cooking compartment and the second cooking compartment, and a second position in which the separation element and the cooking chamber delimit the single main cooking compartment.

11. The cooking appliance according to claim 10, wherein the separation element is movably mounted in translation relative to a frame of the cooking appliance in a displacement direction.

12. The cooking appliance according to claim 10, wherein the separation element is configured to form a bottom wall of the main cooking compartment when the separation element occupies the second position.

13. The cooking appliance according to claim 10, wherein the separation element is configured to form a lateral wall of the main cooking compartment when the separation element occupies the second position.

14. The cooking appliance according to claim 1, wherein the separation element is removable, the separation element being located in the cooking chamber when the cooking appliance is in the first use configuration and capable of being removed from the cooking chamber when the cooking appliance s in the second use configuration.

15. The cooking appliance according to claim 1, further comprising a steam generating device configured to generate a steam flow in the cooking chamber.

16. The cooking appliance according to claim 15, wherein a food disposed in the first cooking compartment is capable of being in contact with the steam flow generated by the steam generating device and/or a food disposed in the second cooking compartment is capable of being in contact with the steam flow generated by the steam generating device when the cooking appliance is in the first use configuration, and in which a food disposed in the main cooking compartment is capable of being in contact with the steam flow generated by the steam generating device when the cooking appliance is in the second use configuration.

17. The cooking appliance according to claim 15, further comprising a control unit configured to control the operation of the steam generating device and simultaneously control the operation of the upper heating device and/or the lower heating device when the cooking appliance is in the first use configuration or in the second use configuration.
